(19) United States
(12) Patent Application Publication
(10) Pub. No.: US 2015/0132052 A1
(43) Pub. Date: May 14, 2015

(54) COUPLING ELEMENT, COUPLING ARRANGEMENT AND METHOD FOR PRODUCING A COUPLING ELEMENT

(71) Applicant: Hirschvogel Umformtechnik GmbH, Denklingen (DE)

(72) Inventors: Tobias HOFMANN, Stoettwang (DE); Christian SEEL, Utting (DE); Ulrich RIEDEL, Burggen (DE)

(21) Appl. No.: 14/469,053

(22) Filed: Aug. 26, 2014

(30) Foreign Application Priority Data
Sep. 5, 2013 (DE) 10 2013 217 753.4

(51) Int. Cl. F16D 1/02

(52) U.S. Cl. CPC F16D 1/02
USPC 403/364

(57) ABSTRACT

A coupling element with an axis of rotation (A), about which the coupling element can rotate, having a plane-sided spur toothing extending axially with respect to the axis of rotation (A) and having teeth, the spur toothing being designed in such a way that it can engage into a plane-sided countertoothing of a second coupling element for the transmission of a torque about the axis of rotation and the first coupling element and the second coupling element are connectable fixedly in terms of rotation to one another. A coupling arrangement with coupling elements and a method for producing the coupling element is also disclosed.

### CROSS-REFERENCE TO RELATED APPLICATIONS

This application claims priority to German Patent Application No. 10 2013 217 753.4 filed Sep. 5, 2013, the disclosure of which is hereby incorporated in its entirety by reference herein.

### TECHNICAL FIELD

The present embodiment relates to a coupling element with spur toothing, such as, for example, a wheel hub or a rotary joint, to a coupling arrangement, such as, for example, a wheel hub/rotary joint arrangement, and to a method for producing the coupling element.

### BACKGROUND

Coupling arrangements are known from the prior art, which, in particular, have a wheel hub and a synchronizing rotary joint as coupling elements connected fixedly in terms of rotation to one another. For the rotationally fixed connection of the two coupling elements and therefore for torque transmission about a common axis of rotation, the two coupling elements have in each case a spur toothing or countertoothing extending axially with respect to the axis of rotation, said toothings coming into or being in engagement with one another. The two coupling elements are braced or bracable axially by a bracing means, such as a screwbolt, in order to maintain the rotationally fixed gearwheel connection.

DE 10 2005 054 283 B4 discloses a wheel hub/rotary joint arrangement of the type initially mentioned, which is shown diagrammatically in FIG. 3, the tooth tip lines 1011 (only two are illustrated by way of example for the sake of clarity) and tooth root lines 1012 of the toothing 1010 or at least one of the two components 1000 (that is to say, wheel hub and/or synchronizing rotary joint) intersecting one another not only, as is sufficiently known, at an intersection point or intersection points lying radially within the spur toothing, but this one intersection point 1020 also lying on the axis of rotation 1030 of the wheel hub/rotary joint arrangement or of its two components 1000 (that is to say, wheel hub and synchronizing rotary joint). All the intersection axes consequently meet at a point on the axis of rotation. According to an especially preferred embodiment, the two intersection points of all the tooth tip lines 1011 and tooth root lines 1012 of one spur toothing 1010 and all the tooth tip lines and tooth root lines of the other spur toothing lie, at least in the completely braced state of the coupling arrangement, at a single point on the common axis of rotation 1030.

The wheel hub/rotary joint arrangements are usually provided in vehicles which can implement a main driving direction (for example, forward drive) and a secondary driving direction (for example, reverse drive). In the known embodiments of radially extending spur (serrated) toothings, the bearing surface of the corresponding tooth flanks and therefore the load-bearing surface of the corresponding teeth are of identical size in both directions of rotation of the coupling arrangement. The teeth are therefore designed identically for both driving directions, even though the load upon the tooth flanks is markedly greater in the main driving direction over the lifetime of the arrangement.

An object of the present embodiment, therefore, is to provide a coupling element and a corresponding coupling arrangement, by means of which the different loads or the different load duration in a main and in a secondary driving direction are taken into account in a simple way.

### SUMMARY

This object is achieved by means of the subject matter of the independent claims. The dependent claims develop the central idea of the embodiments in an especially advantageous way.

According to a first aspect, the embodiment relates to a coupling element with an axis of rotation, about which the coupling element can rotate. The coupling element has a plane-sided spur toothing extending axially with respect to the axis of rotation and having teeth, the spur toothing being designed in such a way that it can engage into a plane-sided countertoothing of a second coupling element for the transmission of a torque about the axis of rotation and the first coupling element and the second coupling element are connectable fixedly in terms of rotation to one another. According to the embodiment, at least none of the tooth tip lines of the teeth of the spur toothing or at least none of the tooth root lines of the teeth of the spur toothing runs through the axis of rotation of the coupling element. In other words, all of the tooth tip lines and/or all the tooth root lines run past the axis of rotation of the coupling element. According to an especially preferred embodiment, none of the tooth tip lines and none of the tooth root lines of the teeth of the spur toothing runs through the axis of rotation of the coupling element.

In the context of the disclosed embodiments, a tooth tip line or tooth root line designates those axes which are formed by the intersection of the tooth flanks with one another. In concrete terms, therefore, the tooth tip line is formed in that the planes extending along the right and the left tooth flank of a tooth intersect one another. The resulting intersection line forms an axis, along which the tooth tip line runs. Correspondingly, the tooth root line is formed by intersection of the plane extending along the left tooth flank of a tooth with the plane extending along the right tooth flank of the adjacent tooth; or, in other words, by the intersection of two tooth flanks (or their planes) of a tooth space.

Preferably, a first point on the corresponding tooth tip line or a second point on the corresponding tooth root line, which point is in each case nearest to the axis of rotation (at least as seen in a top view of the spur toothing, that is to say in the axial direction), may be at a predetermined distance from the axis of rotation; depending on whether only none of the tooth tip lines, only none of the tooth root lines or none of the tooth tip lines and of the tooth root lines runs through the axis of rotation. The distance of the first point of the tooth tip lines or the distance of the second point of the tooth root lines are especially preferably identical, and therefore none of the tooth tip lines and none of the tooth root lines runs through the axis of rotation of the coupling element.

Preferably, furthermore, at least the tooth tip lines of the teeth of the spur toothing extend, as seen in the axial direction of the coupling element (that is to say, in a top view of the toothing), at a predetermined angle 0°<α<90°, preferably 5°<α<45°, in each case with respect to a radial running through the axis of rotation and the mid-point of the corresponding tooth or tooth tip, or at least the tooth root lines of the teeth of the toothings extend, as seen in the axial direction of the coupling element (that is to say, in a top view of the toothing), at a predetermined angle 0°<β<90°, preferably 5°<β<45°, in each case with respect to a radial running through the axis of rotation and the mid-point of the corresponding tooth interspace (as seen in the circumferential direction) or tooth root. Consequently, all the tooth tip lines and tooth root lines can therefore also extend at the predetermined angle, which may preferably be identical, that is to say α=β, in each case with respect to the corresponding radial.

According to a second aspect, of one or more of the embodiments, a coupling element of the above-described type with an axis of rotation, about which the coupling element can rotate, having a plane-sided spur toothing extending axially with respect to the axis of rotation and having teeth, the spur toothing being designed in such a way that it can engage into a plane-sided countertoothing of a second coupling element for the transmission of a torque about the axis of rotation and the first coupling element and the second coupling element are connectable fixedly in terms of rotation to one another. Accordingly, the second, at least the tooth tip lines of the teeth of the spur toothing extend, as seen in the axial direction of the coupling element (that is to say, in a top view of the toothing), at a predetermined angle 0°<α<90°, preferably 5°<α<45°, in each case with respect to a radial running through the axis of rotation and the mid-point of the corresponding tooth or tooth tip, or at least the tooth root lines of the teeth of the toothings extend, as seen in the axial direction of the coupling element (that is to say, in a top view of the toothing), at a predetermined angle 0°<β<90°, preferably 5°<α<45°, in each case with respect to a radial running through the axis of rotation and the mid-point of the corresponding tooth interspace or tooth root.

According to a preferred embodiment, the abovementioned angles α and β are identical.

Whereas in the known Hirth toothing, for example according to DE 10 2005 054 283 B4, all the axes of the tooth tip lines and tooth root lines intersect/meet at a point on the axis of rotation or mid-axis of the wheel hub/rotary joint arrangement, in the toothing of the coupling element according to a disclosed embodiment, at least the tooth tip lines or the tooth root lines or both the tooth tip lines and tooth root lines do not all run through the mid-axis or axis of rotation of the corresponding coupling element and are especially preferably (in each case) all arranged askew to one another. Thus, the corresponding axes/lines consequently meet/intersect, at least as seen in a top view of the spur toothing, that is to say in the axial direction of the spur toothing, at different points outside the axis of rotation and preferably around the latter and, furthermore, preferably radially within the spur toothing. The intersection axes of the tooth tip lines and/or of the tooth root lines according to a disclosed embodiment therefore all meet, if at all, outside the axis of rotation. The tooth tip lines and/or tooth root lines running obliquely, as seen in the top view of the spur toothing, make it possible to provide a spur (serrated) toothing in which the teeth do not simply extend in the radial direction but at least partially obliquely to the corresponding radial, in such a way that the tooth flanks of the teeth are all made larger, as seen in a specific circumferential direction, than the tooth flanks in the corresponding counter circumferential direction. Thus, the tooth flanks loaded in the main driving direction can be made larger, so that not only can the toothing per se be made smaller overall, assuming the same use, than hitherto known coupling elements, but also the lifetime of the toothing is positively influenced.

Moreover, as a result of the preferably slightly oblique arrangement of the teeth in the embodiment according to the disclosed embodiment of the coupling element, tooth filling is assisted in a tumbling process used for producing the toothing, and in this case the tooth direction should match with the tumbling direction for this purpose.

Preferably, at least all the tooth tip lines are tangent to a single (first) circle which is preferably formed coaxially about the axis of rotation, or at least all the tooth root lines are tangent to a single (second) circle which is preferably formed coaxially to the axis of rotation. Consequently, all the tooth tip lines and tooth root lines can also be in each case tangent to a single circle which is preferably formed coaxially to the axis of rotation. Especially preferably, in the last-mentioned case, preferably the circles, to which in each case all the tooth tip lines and all the tooth root lines are tangent, have the same diameter, and therefore the circles are identical.

The circles preferably lie in a plane which extends orthogonally to the axis of rotation; this also applies to the circles mentioned hereafter. Furthermore, preferably, the contact points occur between tooth tip lines or tooth root lines and the corresponding circle, at least as seen in the top view of the spur toothing, that is to say in the axial direction.

If the spur toothing is seen in a top view, that is to say seen in the axial direction of the spur toothing, intersection points or meeting points of tooth tip lines with one another or of tooth root lines with one another or of tooth tip lines and tooth root lines are obtained. These “intersection points” do not in this case constitute necessarily actual intersection points of the corresponding lines in space. For example, in the case where corresponding groups of tooth tip lines and/or tooth root lines are oriented askew to one another, these intersection points are due to the viewing angle of the toothing from above and are therefore viewing angle-dependent. In this view (top view), however, an intersection point may be present (as seen from above; that is to say in the corresponding two-dimensional view), even if there is actually no geometric intersection point in three-dimensional space. Hereafter, therefore, intersection point is understood to mean not only the actual intersection point in space, but, in particular, also the viewing angle-dependent intersection point.

The intersection points of in each case two adjacent tooth tip lines (at least those when the toothing is seen in the top view) preferably all differ from one another. Alternatively or additionally, the intersection points (at least those when the toothing is seen in the top view) of in each case two adjacent tooth root lines preferably all likewise differ from one another.

According to an especially preferred embodiment, the intersection points (at least those when the toothing in seen in the top view) of in each case two adjacent tooth tip lines all lie on a circle which is preferably formed or arranged coaxially to the axis of rotation; that is to say, is formed around the axis of rotation. Alternatively or additionally, the intersection points (at least those when the toothing is seen in the top view) of in each case two adjacent tooth root lines likewise all lie on a circle which is preferably formed coaxially to the axis of rotation.

According to an especially preferred embodiment, these intersection points of in each case two adjacent tooth tip lines and in each case two adjacent tooth root lines all lie on a circle which is preferably formed coaxially to the axis of rotation.

According to a further more preferred embodiment, the intersection points (at least those when the toothing is seen in the top view) of in each case an adjacent tooth root line and a tooth tip line all lie on a circle which is preferably formed coaxially to the axis of rotation.

According to the abovementioned developments of the embodiments, it becomes possible, furthermore, to provide a coupling element, the obliquely set teeth of which, on the one hand, can be produced in a simple way and, on the other hand, allow simple assembling/coupling with a correspondingly matching coupling element of the type according to the a disclosed embodiment by toothing engagement.

According to a third aspect, a disclosed embodiment relates, furthermore, to a coupling arrangement with an axis of rotation, about which the coupling arrangement can rotate. The coupling arrangement has, furthermore, a first coupling element according to the embodiment with a plane-sided spur toothing extending axially with respect to the axis of rotation and having first teeth, and a second coupling element according to the embodiment with a plane-sided countertoothing extending axially with respect to the axis of rotation and having second teeth. The first and the second coupling elements are connectable fixedly in terms of rotation to one another by an axial engagement of the spur toothing and of the countertoothing for the transmission of a torque about the axis of rotation. For this purpose, the coupling elements are preferably of mirror-symmetrical configuration. To connect the two coupling elements to form a coupling arrangement, the coupling arrangement preferably has, furthermore, at least one bracing means for the axial bracing of the first coupling element with the second coupling element, the bracing means preferably being designed as a bracing screw.

Preferably, at least one of the toothings (that is to say, the spur toothing and/or countertoothing) of the coupling element is predistorted in such a way that the tooth tip lines run toward the tooth root lines, as seen in the axial direction, from a radially outer end of the teeth to a radially inner end of the teeth. According to an especially preferred embodiment, the tooth tip lines of at least one spur toothing or countertoothing are at a shorter distance from the tooth root lines of the opposite spur toothing or countertoothing at their radially outer end of the teeth than at their radially inner end. This predishing, as it may be referred to, allows first contact of the tooth flanks of matching teeth of two installable coupling elements with one another initially at a radially outer region of the teeth, and, during the further assembling of the two coupling elements, if appropriate under the action of an additional bracing force by a bracing means, the tooth flanks increasingly also come to bear radially with respect to the axis of rotation, until the tooth flanks lie one on the other over their entire area in the ready-mounted coupling arrangement. This, in turn, leads to reliable contact of the teeth, particularly in a radially outer region of these at which the highest loads upon the toothing occur.

One or more of the embodiments relate to a method for producing one of the disclosed coupling elements, the toothing or the teeth preferably being introduced into the coupling element or the component blank by means of a tumbling process, preferably in such a way that the tooth direction (that is to say, the longitudinal orientation of the teeth preferably in the radial plane) matches with the tumbling direction.

Further advantages, refinements and developments of the various embodiments are described below with reference to the drawings of the accompanying figures.

### BRIEF DESCRIPTION OF THE DRAWINGS

FIG. 1A shows in general, an exploded illustration of a coupling arrangement with coupling elements,

FIG. 1B shows in general, a perspective lateral sectional view of a joint outer part of a synchronizing rotary joint (that is to say, of a (second) coupling element),

FIG. 2 shows a diagrammatic perspective view of a coupling element according to one embodiment,

FIG. 3 shows a diagrammatic perspective view of a coupling element according to the prior art.

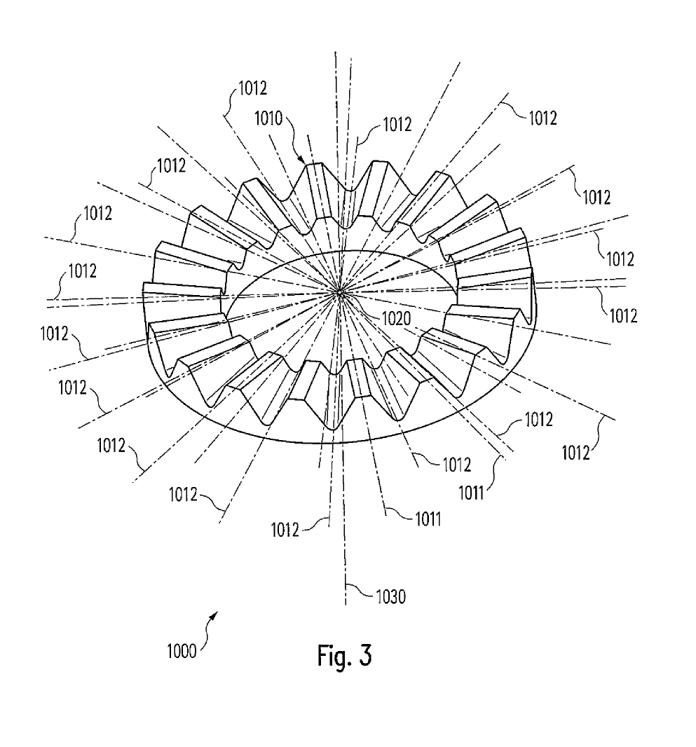

### DETAILED DESCRIPTION

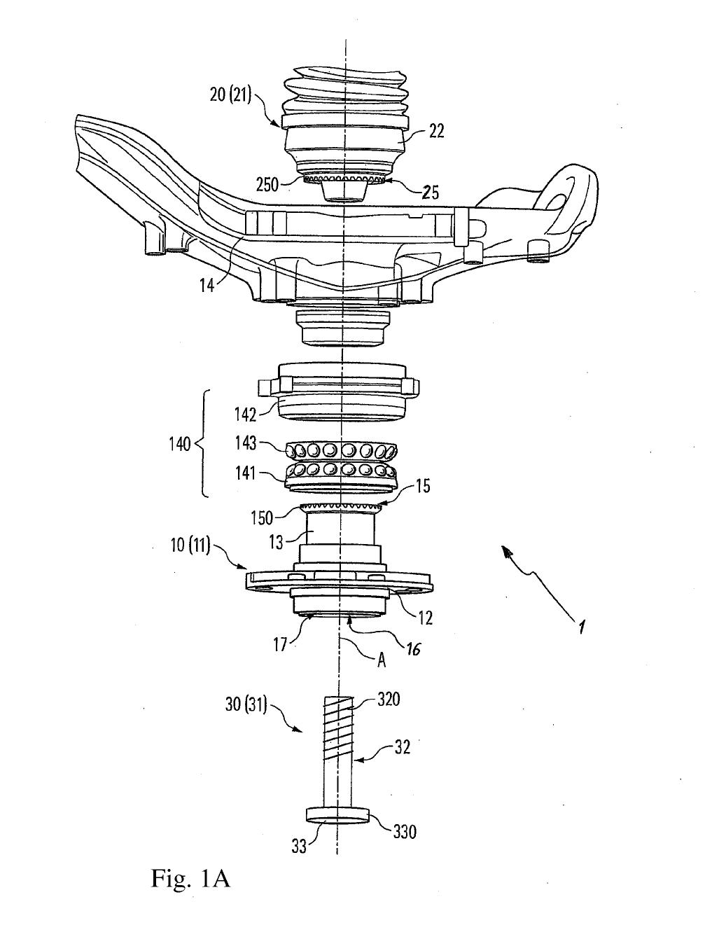

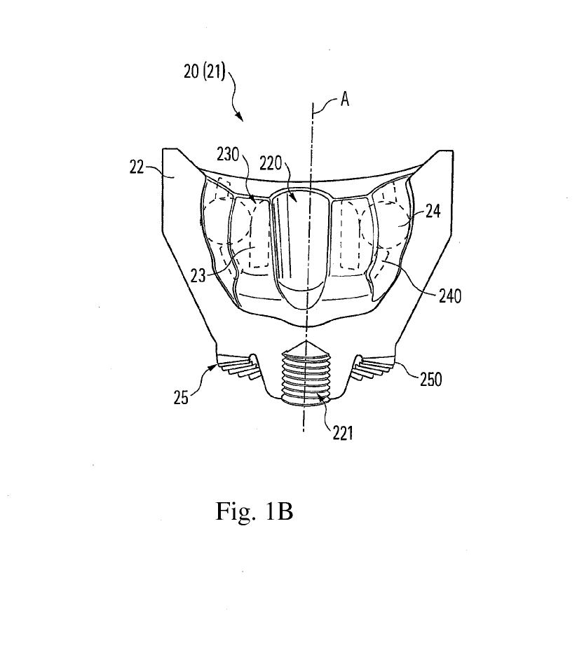

FIG. 1A shows by way of example, in general, a coupling arrangement 1, such as may basically also be provided according to the one embodiment. Such a coupling arrangement 1 has an axis of rotation A, about which the coupling arrangement 1 can rotate.

Moreover, the coupling arrangement 1 has a first coupling element 10. The first coupling element 10 is preferably designed as a wheel hub 11. The wheel hub 11 preferably has a wheel flange 12 for connecting the wheel (not shown) to a sleeve portion 13 for receiving a wheel mounting 14. The sleeve portion 13, for this purpose, is preferably formed integrally with an inner bearing ring of a bearing 140 for the rotatable connection of the wheel hub 11 to the wheel mounting 14. Alternatively, as shown in FIG. 1A, the sleeve portion 13 may serve for the rotationally fixed reception of an inner bearing ring 141 of the bearing 140. The bearing 140 preferably has, furthermore, an outer bearing ring 142 which, in turn, is connected fixedly in terms of rotation to the wheel mounting 14, wherein, for rotatable connection between the inner bearing ring 141 and the outer bearing ring 142, rolling bodies 143 are preferably provided which run on raceways of the respective bearing ring 141, 142. Preferably, the bearing 140 is designed as a double-row angular ball bearing, as shown in FIG. 1A.

The first coupling element 10 has a plane-sided spur toothing 15 extending axially with respect to the axis of rotation A and having first teeth 150.

The coupling arrangement 1 has, furthermore, a second coupling element 20 which is also illustrated in more detail in FIG. 1B. Correspondingly to the first coupling element 10, the second coupling element 20 also has a plane-sided spur toothing in the form of a countertoothing 25 extending axially with respect to the axis of rotation A and having second teeth 250, said toothing engaging axially into the spur toothing 15 of the first coupling element 10. The spur toothing 15 and the countertoothing 25 are preferably of mirror-symmetrical configuration.

The second coupling element 20 is preferably designed as a rotary joint 21, especially preferably as a synchronizing rotary joint. The synchronizing rotary joint 21 preferably has a joint outer part 22 with outer ball tracks 220, a joint inner part 23 with inner ball tracks 230 (in each case illustrated diagrammatically) and torque-transmitting elements 24, preferably balls, arranged in each case in a pair of an outer ball track 220 and of an inner ball track 230, and a cage 240 holding the torque-transmitting elements 24 (in each case illustrated diagrammatically).

If the first coupling element 10 is designed as a wheel hub 11, preferably the sleeve portion 13 has the spur toothing 15 at its end facing the second coupling element 20 or rotary joint 21. If the second coupling element 20 is then designed as a rotary joint 21, the joint outer part 22 has the countertoothing 25 at its end facing the wheel hub 11, said spur toothing and said countertoothing consequently being brought into engagement for the rotationally fixed connection of the first coupling element 10 and of the second coupling element 20.

The coupling arrangement 1 has, furthermore, preferably at least one bracing means 30 for the axial bracing of the first coupling element 10 with the second coupling element 20, which are connectable/connected fixedly in terms of rotation to one another via the spur toothing 15 and the countertoothing 25 for the transmission of a torque about the axis of rotation A. The bracing means 30 is preferably supported axially, on the one hand, on the first coupling element 10, that is to say preferably the wheel hub 11, and, on the other hand, on the second coupling element 20, that is to say preferably the joint outer part 22 of the (synchronizing) rotary joint 21. For this purpose, the second coupling element 20, that is to say preferably the joint outer part 22, has, in particular, a central threaded bore 221, into which the bracing means 30 engages. The bracing means 30 is then preferably designed as a bracing screw or threaded bolt 31; has, therefore, a threaded shank 32 with an external thread 320, said threaded shank preferably matching with the threaded bore 221 with a nonpositive connection. The threaded bolt 31 or the bracing means 30 is preferably inserted into a central (continuous) bore 16 of the first coupling element 10, preferably the wheel hub 11, and is screwed into the threaded bore 221 of the second coupling element 20. The bracing means 30 is designed, furthermore, in such a way that it is supported axially on a radial supporting surface 17 of the first coupling element 10 in the screwed-in state. For this purpose, the bracing means 30 preferably has an annular flange 330 which has a larger diameter than the central bore 16 and is supported, with the regions engaging over the central bore 16, on the supporting surface 17. Preferably, the annular flange 330 is formed by a screw head or bolt head 33 of the bracing means 30.

An abovementioned coupling arrangement 1 having two matching coupling elements 10, 20, such as, for example, a wheel hub 11 and a (synchronizing) rotary joint 21, is also designated as a wheel hub/rotary joint arrangement which especially preferably is braced/braceable by the bracing means 30.

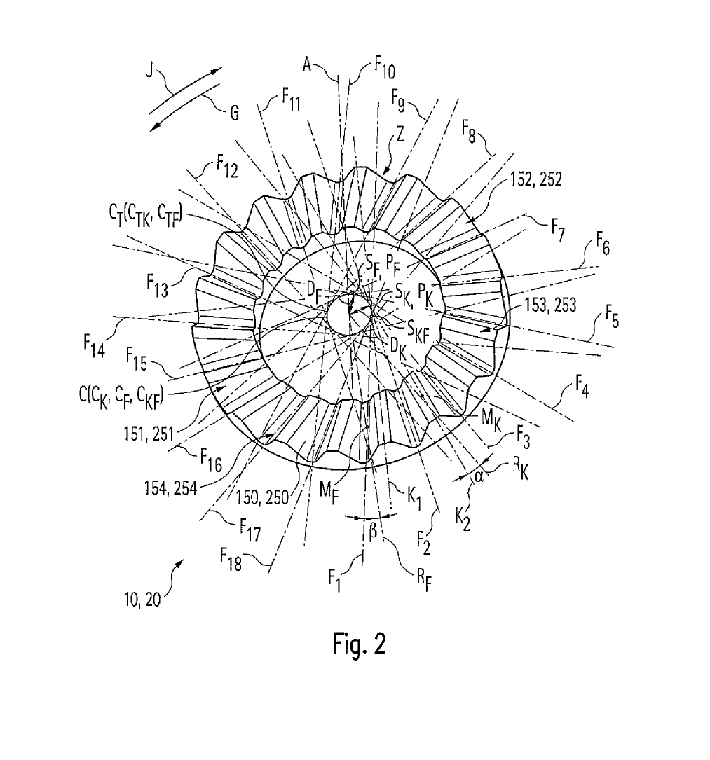

FIG. 2 now shows a diagrammatic and perspective view of the coupling element 10, 20 according to the embodiment with an axis of rotation A and with the spur toothing 15, 25 having teeth 150, 250 according to an embodiment of the embodiment. According to the embodiment, at least none of the tooth tip lines K (only two tooth tip lines K₁ and K₂ are illustrated by way of example for the sake of clarity) of the teeth 150, 250 of the spur toothing 15, 25 or at least none of the tooth root lines F of the teeth 150, 250 of the spur toothing 15, 25 runs through the axis of rotation A of the coupling element 10, 20. In other words, in the toothing 15, 25 of the coupling element 10, 20, if the coupling element 10, 20 is viewed in a top view of the spur toothing 15, 25, as seen in the axial direction, at least the tooth tip lines K or the tooth root lines F or, as shown in FIG. 2, both the tooth tip lines K and the tooth root lines F are all oriented obliquely or preferably also askew to one another and, at least in the top view of the toothing 15, 25, that is to say as seen in the axial direction, meet/intersect preferably at different points outside the axis of rotation A and preferably around the latter and, furthermore, preferably radially within the spur toothing 15, 25. The tooth tip lines K and/or tooth root lines F running obliquely, as seen in the top view of the spur toothing 15, 25, preferably make it possible to provide a corresponding spur (serrated) toothing 15, 25 in which the teeth 150, 250 do not extent in the radial direction (at least as seen in the top view of the toothing), but at least partially obliquely to the corresponding radial R in such a way that the tooth flanks 151, 251 of the teeth 150, 250 are all designed to have a larger surface, as seen in a circumferential direction U, than the tooth flanks 152, 252, as seen in the corresponding counter circumferential direction G. Thus, for example, the tooth flanks 151, 251 loaded in a main driving direction (for example, forward drive) of the vehicle having the coupling arrangement 1 can be made larger than the tooth flanks 152, 252 loaded in the secondary driving direction (for example, reverse drive), so that not only can the toothing 15, 25 per se be made smaller overall, assuming the same use, than that of hitherto known coupling elements, but also the lifetime of the toothing 15, 25 is positively influenced.

Moreover, as a result of the preferably slightly oblique arrangement of the teeth 150, 250 in the embodiment according to the embodiment of the coupling element 10, 20, tooth filling is assisted in a tumbling process used for producing the toothing 15, 25, and in this case the tooth direction should match with the tumbling direction for this purpose.

A first point P_{K} on the corresponding tooth tip line K or a second point P_{F} on the corresponding tooth root line F, which point is in each case nearest to the axis of rotation A, at least when the toothing 15, 25 is viewed in the top view, that is to say as seen in the axial direction, is preferably at a predetermined distance D_{K}, D_{F} from the axis of rotation A. It would be appreciated that the distance D_{K} or D_{F} for the tooth tip lines K and/or tooth root lines F depends on whether only none of the tooth tip lines K, only none of the tooth root lines F or none of the tooth tip lines K and of the tooth root lines F runs through the axis of rotation A. The distance D_{K}, D_{F} is preferably fixed in such a way that it is greater than the corresponding tolerance range for producing the corresponding toothing 15, 25 and can therefore be predetermined in a targeted manner. The distance D_{K} of the first point P_{K} of the tooth tip lines K and the distance D_{F} of the second point P_{F} of the tooth root lines F in each case from the axis of rotation A are preferably identical, as show in FIG. 2.

Alternatively or additionally, according to the embodiment, at least the tooth tip lines K of the teeth 150, 250 of the spur toothing 15, 25 extend, as seen in the axial direction of the coupling element 10, 20 (that is to say, in a top view of the toothing 15, 25), at a predetermined angle 0°<α<90° in each case with respect to a radial R_{K} running through the axis of rotation A and the mid-point M_{K} of the corresponding tooth 150, 250 or tooth tip 153, 253. Furthermore, alternatively or additionally, at least the tooth root lines F of the teeth 150, 250 of the spur toothing 15, 25 extend, as seen in the axial direction of the coupling element 10, 20 (that is to say, in a top view of the toothing 15, 25), at a predetermined angle 0°<β<90° in each case with respect to a radial R_{F} running through the axis of rotation A and the mid-point M_{F} of the corresponding tooth interspace Z or tooth root 154, 254. Consequently, when the toothing 15, 25 is viewed in the axial direction, the angle α and the angle β lie in a plane which extends orthogonally to the axis of rotation A. Consequently, all the tooth tip lines K and tooth root lines F can therefore also in each case extend at the predetermined angle α, β with respect to the corresponding radials R_{K}, R_{F}. Preferably, the angles are fixed in a range 5°<α<45° and 5°<β<45° respectively. According to an especially preferred embodiment, the angles α and β are designed identically, as also illustrated in FIG. 2.

The mid-point of the tooth 150, 250 is determined by its geometric mid-point. The mid-point of the tooth interspace Z is likewise determined by the geometric mid-point of the space delimited laterally by two adjacent teeth 150, 250. The mid-point of the tooth tip 153, 253 or of the tooth root 154, 254 is preferably determined as the geometric mid-point in a two-dimensional plane, corresponding to a radial plane of the coupling element 10, 20, in a top view of the coupling element 10, 20 or of the toothing 15, 25.

The oblique configuration of the teeth 150, 250 contributes to the fact that, in particular, as seen in a circumferential direction U, the tooth flanks 151, 152 on the side of the corresponding tooth 150, 250 on which the load comes to bear in the main driving direction are made larger, while the tooth flanks 152, 252 on which the load comes to bear in a secondary driving direction, as seen in the counter circumferential direction G, are consequently made smaller. Thus, correspondingly to the load upon the tooth flanks 151, 152, 251, 252, the size of the tooth flanks 151, 152, 251, 252 can be optimized and the toothing 15, 25 can consequently be designed to be smaller overall, while at the same time the lifetime of the toothing 15, 25 is positively influenced.

According to a preferred embodiment, at least all the tooth tip lines K are tangent to a single circle C_{TK} which is preferably formed coaxially about the axis of rotation A. Alternatively or additionally, at least all the tooth root lines F are tangent to a single circle C_{TF} which is preferably formed coaxially to the axis of rotation A. According to an especially preferred embodiment, preferably the (two) circles C_{TK} and C_{TF}, to which in each case all the tooth tip lines K and all the tooth root lines F are tangent, have the same diameter; they are therefore the same and preferably also identical when they are both formed coaxially about the axis of rotation A. These circles C_{T} consequently lie preferably in a plane orthogonal to the axis of rotation A, this also applying to the circles mentioned hereafter, the contact points with the tooth tip lines K or tooth root lines F occurring at least in a top view of the toothing 15, 25, that is to say as seen in the axial direction.

As may be gathered, furthermore, from FIG. 2, the intersection points S_{K}, occurring at least in the top view (as seen in the axial direction) of the spur toothing 15, 25, of in each case two adjacent tooth tip lines K (intersection points S_{K} shown, for example, for the intersection point of the tooth tip lines K₁ and K₂) preferably all differ from one another. Alternatively or additionally (the latter is shown in FIG. 2), the intersection points S_{F}, occurring at least in the top view (as seen in the axial direction) of the spur toothing 15, 25, of in each case two adjacent tooth root lines F (intersection points S_{F} shown, for example, for the intersection point of the tooth root lines F₅ and F₆) likewise preferably all differ from one another.

As already stated above, the abovementioned intersection points and those also listed hereafter are not necessarily intersection points, actually occurring in three-dimensional space, of two lines, but instead these intersection points are viewing-angle-dependent and consequently, particularly at least in a top view of the toothing 15, 25, as seen in the axial direction, occur even when the tooth tip lines K and/or tooth root lines F are oriented askew to one another. However, the intersection points mentioned herein may, in the top view, coincide with actual intersection points in space.

According to an especially preferred embodiment, the intersection points S_{K}, occurring at least in the top view (as seen in the axial direction) of the spur toothing 15, 25, of in each case two adjacent tooth tip lines K preferably all lie on a circle C_{K}. Alternatively or additionally (the latter is shown in FIG. 2), the intersection points S_{F}, occurring at least in the top view (as seen in the axial direction) of the spur toothing 15, 25, of in each case two adjacent tooth root lines F likewise preferably all lie on a circle C_{F}. The abovementioned circles C_{K} and C_{F} are preferably formed or arranged coaxially to the axis of rotation A.

According to an especially preferred embodiment, the intersection points S_{K} and S_{F}, occurring at least in the top view (as seen in the axial direction) of the spur toothing 15, 25, of in each case two adjacent tooth tip lines K and in each case two adjacent tooth root lines F all lie on a common circle C which is especially preferably formed or arranged coaxially to the axis of rotation A. Consequently, according to this embodiment, the circles C_{K} and C_{F} are therefore identical, as is illustrated according to the embodiment shown in FIG. 2.

According to a further preferred embodiment, the intersection points S_{KF}, occurring at least in the top view (as seen in the axial direction) of the spur toothing 15, 25, of in each case an adjacent tooth root line F and a tooth tip line K all lie on a circle C_{KF} which is especially preferably likewise formed coaxially to the axis of rotation A and especially preferably is congruent with at least one of the circles C, C_{K} and C_{F}.

The circles C_{K} and/or C_{F} and/or C_{KF} may have a different or the same diameter and also, in the last-mentioned case, be identical; particularly when all the circles are formed coaxially around the axis of rotation.

This preferably symmetrical configuration of the tooth tip lines K and/or tooth root lines F, as described above, ensures especially simple production of the toothing 15, 25, particularly by means of a tumbling process, and in this case, in this process, the tooth direction should preferably match with the tumbling direction. As a result of the slightly oblique arrangement of the teeth 150, 250, tooth filling is assisted during the tumbling process. The symmetrical configuration likewise ensures a simple and reliable assembling of coupling elements 10, 20 of correspondingly matching configuration to form an abovementioned coupling arrangement 1 having a common axis of rotation A. In principle, however, a symmetrical configuration of the teeth 150, 250 is not absolutely necessary, for as long as the respective coupling elements 10, 20 have a preferably mirror-symmetrical configuration. In this case, however, the coupling elements 10, 20 should have provided on them corresponding aligning elements which make it possible simply and preferably automatically to orient the coupling elements 10, 20 correctly with one another in order to construct a coupling arrangement 1.

As may be gathered, furthermore, from FIG. 2, the toothing 15, 25 is preferably predistorted; preferably in such a way that the tooth tip lines K and the tooth root lines F run relatively toward one another, as seen in the axial direction, from a radially outer end of the teeth 150, 250 to a radially inner end of the teeth 150, 250, especially preferably the tooth tip lines K run toward the tooth root lines F in the axial direction from a radially outer end of the teeth 150, 250 to a radially inner end of the teeth 150, 250. For the coupling arrangement 1, with the corresponding countertoothing 25, 15 of the other coupling element 20, 10 being designed correspondingly, this preferably means that the tooth tip lines K of at least one spur toothing 10 or countertoothing 20 are at a shorter distance at their radially outer end of the corresponding teeth 150, 250 from the tooth root lines F of the opposite spur toothing 10 or countertoothing 20 than at their radially inner end. However, in principle, such predishing is also possible in another way by means of an appropriate geometric configuration of the spur toothing or countertoothing.

Predishing preferably allows first contact of the tooth flanks 151, 152, 251, 252 of matching teeth 150, 250 of two installable coupling elements 10, 20 with one another initially at a radially outer region of the teeth 150, 250, and, during the further assembling of the two coupling elements 10, 20, if appropriate under the action of an additional bracing force by the bracing means 30, the tooth flanks increasingly also come to bear radially as viewed toward the axis of rotation until the tooth flanks 151, 152, 251, 252 lie one on the other over their entire area in the ready-mounted coupling arrangement 1. Thus, reliable contact of the teeth 150, 250 of the toothing 15, 25, particularly in the radially outer region of these at which the highest forces take effect, can become possible.

It was already explained above that the various embodiments may also comprises a coupling arrangement 1 having a first and a second coupling element 10, 20 according to the embodiment. Thus far, reference is made in full to the above statements which apply in the same way to the coupling arrangement 1.

A method for producing a coupling element 10, 20 according to one of the embodiments having an axis of rotation A, about which the coupling element 10, 20 can rotate, will be described hereafter.

In a first step, a component blank for a corresponding coupling element 10, 20 is provided. A plane-sided spur toothing 15, 25 extending axially with respect to the axis of rotation and having teeth 150, 250 is then introduced into the component blank in order to produce a coupling element 10, 20, the spur toothing 15, 25 being designed in such a way that it can engage into a plane-sided countertoothing 25, 15 of a second coupling element 20, 10 for the transmission of a torque about the axis of rotation A and the first coupling element 10, 20 and the second coupling element 20, 10 are connectable fixedly in terms of rotation to one another.

According to an embodiment, the toothing 15, 25 or the teeth 150, 250 are introduced in such a way that at least the tooth tip lines K of the teeth 150, 250 of the toothing 15, 25 or at least the tooth root lines F of the teeth 150, 250 of the toothing 15, 25 or both the tooth tip lines K and the tooth root lines F of the toothing 15, 25 all do not run through the axis of rotation A. In other words, the corresponding tooth tip lines K and/or tooth root lines F all run past the axis of rotation A.

Especially preferably, the spur toothing 15, 25 is introduced into the component blank in such a way that at least the tooth tip lines K of the teeth 150, 250 of the spur toothing 15, 25 extend, as seen in the axial direction of the coupling element 10, 20, at a predetermined angle 0°<α<90°, preferably 5°<α<45°, in each case with respect to a radial R_{K} running through the axis of rotation A and the mid-point M_{K} of the corresponding tooth tip 150, 250, or at least the tooth root lines F of the teeth 150, 250 of the spur toothing 15, 25 extend, as seen in the axial direction of the coupling element 10, 20, at a predetermined angle 0°<β<90°, preferably 5°<β<45°, in each case with respect to a radial R_{F} running through the axis of rotation A and the mid-point M_{F} of the corresponding tooth root 253.

The teeth are preferably introduced into the component blank by means of a tumbling process, the tooth direction or longitudinal orientation of the teeth 150, 250 (consequently the directions of the tooth root lines F and/or of the tooth tip lines K) matching with the tumbling direction. Thus, tooth filling is assisted during the tumble-pressing process and the method is therefore markedly simplified and accelerated, and at the same time the component quality can also be increased.

The various embodiments are not restricted to the preceding exemplary examples as long as it is covered by the subject matter of the following claims. Furthermore, the preceding exemplary embodiments can be combined with one another in any desired way.

What is claimed is:

1. A coupling element having an axis of rotation (A), about which the coupling element can rotate, comprising a plane-sided spur toothing extending axially with respect to the axis of rotation (A) and having teeth, the spur toothing being designed in such a way that it can engage into a plane-sided countertoothing of a second coupling element for the transmission of a torque about the axis of rotation (A) and the first coupling element and the second coupling element are connectable fixedly in terms of rotation to one another, wherein at least none of the tooth tip lines (K) of the teeth of the spur toothing or at least none of the tooth root lines (Z) of the teeth of the spur toothing run through the axis of rotation (A).

2. The coupling element as claimed in claim 1, a first point (P_{K}) on the corresponding tooth tip line (K) or a second point (P_{F}) on the corresponding tooth root line (Z), which point is in each case nearest to the axis of rotation (A) at least in a top view of the spur toothing, as seen in the axial direction, being at a predetermined distance (D_{K}, D_{F}) from the axis of rotation (A), preferably the distance (D_{K}) of the first point (P_{K}) of the tooth tip lines (K) and the distance (D_{F}) of the second point (P_{F}) of the tooth root lines (Z) being identical.

3. The coupling element as claimed in claim 1, at least the tooth tip lines (K) of the teeth of the spur toothing extending, as seen in the axial direction of the coupling element, at a predetermined angle 0°<α<90°, preferably 5°<α<45°, in each case with respect to a radial (R_{K}) running through the axis of rotation (A) and the mid-point (M_{K}) of the corresponding tooth tip, or at least the tooth root lines (F) of the teeth of the spur toothing extending, as seen in the axial direction of the coupling element, at a predetermined angle 0°<β<90°, preferably 5°<β<45°, in each case with respect to a radial (R_{F}) running through the axis of rotation (A) and the mid-point (M_{F}) of the corresponding tooth root.

4. A coupling element with an axis of rotation (A), about which the coupling element can rotate, having a plane-sided spur toothing extending axially with respect to the axis of rotation (A) and having teeth, the spur toothing being designed in such a way that it can engage into a plane-sided countertoothing of a second coupling element for the transmission of a torque about the axis of rotation (A) and the first coupling element and the second coupling element being connectable fixedly in terms of rotation to one another, wherein at least the tooth tip lines (K) of the teeth of the spur toothing extend, as seen in the axial direction of the coupling element, at a predetermined angle 0°<α<90°, preferably 5°<α<45°, in each case with respect to a radial (R_{K}) running through the axis of rotation (A) and the mid-point (M_{K}) of a corresponding tooth tip, or at least the tooth root lines (F) of the teeth of the spur toothing extend, as seen in the axial direction of the coupling element, at a predetermined angle 0°<β<90°, preferably 5°<β<45°, in each case with respect to a radial (R_{F}) running through the axis of rotation (A) and the mid-point (MF) of the corresponding tooth root.

5. The coupling element as claimed in claim 3, the angles α and β being identical.

6. The coupling element as claimed in claim 1, the tooth tip lines and/or the tooth root lines all being in each case askew to one another.

7. The coupling element as claimed in claim 1, at least all the tooth tip lines (K), as seen at least in the top view of the spur toothing in the axial direction, being tangent to a single circle (C_{TK}) which is preferably formed coaxially about the axis of rotation (A), or at least all the tooth root lines (F), as seen at least in the top view of the spur toothing in the axial direction, being tangent to a single circle (C_{TF}) which is preferably formed coaxially to the axis of rotation (A), and preferably the circles (C_{TK}, C_{TF}), to which in each case all the tooth tip lines (K) and all the tooth root lines (F) are tangent, having the same diameter.

8. The coupling element as claimed in claim 1, always in each case two adjacent tooth tip lines (K) intersecting at intersection points (S_{K}), which all differ from one another, at least in the top view of the spur toothing, as seen in the axial direction, and/or always in each case two adjacent tooth root lines (F) intersecting at intersection points (S_{F}), which all differ from one another, at least in the top view of the spur toothing, as seen in the axial direction.

9. The coupling element as claimed in claim 1, always in each case two adjacent tooth tip lines (K) intersecting intersection points (S_{K}), which all lie on a circle (C_{K}) which is preferably formed coaxially to the axis of rotation (A), at least in the top view of the spur toothing, as seen in the axial direction, and/or always in each case two adjacent tooth root lines (F) intersecting at intersection points (S_{F}), which all lie on a circle (C_{F}) which is preferably formed coaxially to the axis of rotation (A), at least in the top view of the spur toothing, as seen in the axial direction, these intersection points (S_{K}, S_{F}) of in each case two adjacent tooth tip lines (K) and in each case two adjacent tooth root lines (F) preferably all lying on a circle (C) which is preferably formed coaxially to the axis of rotation (A).

10. The coupling element as claimed in claim 1, always in each case an adjacent tooth tip line (K) and tooth root line (F) intersecting at intersection points (S_{KF}), which all lie on a circle (C_{KF}) which is preferably formed coaxially to the axis of rotation (A), at least in the top view of the spur toothing , as seen in the axial direction.

11. The coupling element as claimed in claim 1, the tooth flanks of the teeth being designed to have a larger surface, as seen in a circumferential direction (U), than the tooth flanks of the teeth , as seen in the counter circumferential direction (G).

12. A coupling arrangement with an axis of rotation (A), about which the coupling arrangement can rotate, having:
a first and second coupling elements as claimed in claim 1, the first coupling element having a plane-sided spur toothing extending axially with respect to the axis of rotation (A) and having first teeth, and the second coupling having a plane-sided countertoothing extending axially with respect to the axis of rotation (A) and having second teeth,
the first and the second coupling elements being connectable fixedly in terms of rotation to one another by axial engagement of the spur toothing and of the countertoothing for the transmission of a torque about the axis of rotation (A).

13. The coupling arrangement as claimed in claim 12, having, furthermore, at least one bracing means for the axial bracing of the first coupling element with the second coupling element, the bracing means preferably being designed as a bracing screw.

14. The coupling arrangement as claimed in claim 12, the tooth tip lines (K) of at least one spur toothing or countertoothing being at a shorter distance from the tooth root lines (F) of the opposite spur toothing or countertoothing at their radially outer end of the teeth than at their radially inner end.

15. The coupling element as claimed in claim 4, the angles α and β being identical.

16. The coupling element as claimed in claim 4, the tooth tip lines and/or the tooth root lines all being in each case askew to one another.

17. The coupling element as claimed in claim 4, at least all the tooth tip lines (K), as seen at least in the top view of the spur toothing in the axial direction, being tangent to a single circle (C_{TK}) which is preferably formed coaxially about the axis of rotation (A), or at least all the tooth root lines (F), as seen at least in the top view of the spur toothing in the axial direction, being tangent to a single circle (C_{TF}) which is preferably formed coaxially to the axis of rotation (A), and preferably the circles (C_{TK}, C_{TF}), to which in each case all the tooth tip lines (K) and all the tooth root lines (F) are tangent, having the same diameter.

18. The coupling element as claimed in claim 4, always in each case two adjacent tooth tip lines (K) intersecting at intersection points (S_{K}), which all differ from one another, at least in the top view of the spur toothing, as seen in the axial direction, and/or always in each case two adjacent tooth root lines (F) intersecting at intersection points (S_{F}), which all differ from one another, at least in the top view of the spur toothing, as seen in the axial direction.

19. The coupling element as claimed in claim 4, always in each case two adjacent tooth tip lines (K) intersecting intersection points (S_{K}), which all lie on a circle (C_{K}) which is preferably formed coaxially to the axis of rotation (A), at least in the top view of the spur toothing, as seen in the axial direction, and/or always in each case two adjacent tooth root lines (F) intersecting at intersection points (S_{F}), which all lie on a circle (C_{F}) which is preferably formed coaxially to the axis of rotation (A), at least in the top view of the spur toothing, as seen in the axial direction, these intersection points (S_{K}, S_{F}) of in each case two adjacent tooth tip lines (K) and in each case two adjacent tooth root lines (F) preferably all lying on a circle (C) which is preferably formed coaxially to the axis of rotation (A).

20. The coupling element as claimed in claim 4, always in each case an adjacent tooth tip line (K) and tooth root line (F) intersecting at intersection points (S_{KF}), which all lie on a circle (C_{KF}) which is preferably formed coaxially to the axis of rotation (A), at least in the top view of the spur toothing, as seen in the axial direction.

21. The coupling element as claimed in claim 4, the tooth flanks of the teeth being designed to have a larger surface, as seen in a circumferential direction (U), than the tooth flanks of the teeth, as seen in the counter circumferential direction (G).
